(19) United States
(12) Patent Application Publication
(10) Pub. No.: US 2014/0002696 A1
(43) Pub. Date: Jan. 2, 2014

(54) IMAGE GENERATING APPARATUS

(71) Applicant: Xacti Corporation, Osaka (JP)

(72) Inventor: Yukio Mori, Hirakata-shi (JP)

(21) Appl. No.: 13/929,316

(22) Filed: Jun. 27, 2013

(30) Foreign Application Priority Data
Jun. 27, 2012 (JP) 2012-143681

(51) Int. Cl. H04N 5/262

(52) U.S. Cl. CPC H04N 5/2621
USPC 348/239

(57) ABSTRACT

An image generating apparatus includes an imager. An imager repeatedly outputs an image representing a scene captured on an imaging surface. A composer composes the image outputted from the imager and a designated image in an output cycle of the imager. A storer stores a plurality of composed images generated by the composer. A designator designates, out of the plurality of composed images stored in the storer, a composed image of equal to or more than two cycles past as the designated image.

### CROSS REFERENCE OF RELATED APPLICATION

The disclosure of Japanese Patent Application No. 2012-143681, which was filed on Jun. 27, 2012, is incorporated herein by reference.

### BACKGROUND OF THE INVENTION

1. Field of the Invention

The present invention relates to an image generating apparatus, and in particular, relates to an image generating apparatus which achieves a special effect by using a frame image configuring a moving image.

2. Description of the Related Art

According to one example of this type of apparatus, a solid-state imaging element has a photodiode, a V-CCD and an H-CCD. In a solid-state imaging device having a V-system driving circuit which drives the V-CCD of the solid-state imaging element and an H-system driving circuit which drives the H-CCD, a read-out voltage at a time of reading out a charge from the photodiode to the V-CCD is capable of being changed by a drive-voltage switching circuit. When photographing using a strobe effect is performed, the read-out voltage is lowered, and a photoelectric-conversion charge is forcibly remained in the photodiode at the time of reading-out, so as to generate an accidental image.

However, in the above-described apparatus, a range in which the accidental image appears is limited depending on a speed at which an object appeared in an image moves or a frame rate of an image sensor, and therefore, it is impossible to clearly represent a trajectory of the moving object. Thereby, an effect of a special effect process may be deteriorated.

### SUMMARY OF THE INVENTION

An image generating apparatus according to the present invention comprises: an imager which repeatedly outputs an image representing a scene captured on an imaging surface; a composer which composes the image outputted from the imager and a designated image in an output cycle of the imager; a storer which stores a plurality of composed images generated by the composer; and a designator which designates, out of the plurality of composed images stored in the storer, a composed image of equal to or more than two cycles past as the designated image.

According to the present invention, an image generating program recorded on a non-transitory recording medium in order to control an image generating apparatus provided with an imager which repeatedly outputs an image representing a scene captured on an imaging surface, the program causing a processor of the image generating apparatus to perform the steps comprises: a composing step of composing the image outputted from the imager and a designated image in an output cycle of the imager; a storing step of storing a plurality of composed images generated by the composing step; and a designating step of designating, out of the plurality of composed images stored in the storing step, a composed image of equal to or more than two cycles past as the designated image.

According to the present invention, an image generating method executed by an image generating apparatus provided with an imager which repeatedly outputs an image representing a scene captured on an imaging surface, comprises: a composing step of composing the image outputted from the imager and a designated image in an output cycle of the imager; a storing step of storing a plurality of composed images generated by the composing step; and a designating step of designating, out of the plurality of composed images stored in the storing step, a composed image of equal to or more than two cycles past as the designated image.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of an assigned state of a buffer applied to the embodiment in FIG. 2;

FIG. 5 is an illustrative view showing one example of a composing process;

FIG. 6 is an illustrative view showing another example of the composing process;

FIG. 7 is an illustrative view showing one example of a frame image before the composing process is performed;

FIG. 8 (A) is an illustrative view showing one example of a frame image after composing;

FIG. 8 (B) is an illustrative view showing another example of the frame image after composing;

FIG. 8 (C) is an illustrative view showing still another example of the frame image after composing;

FIG. 9 is a flowchart showing one portion of behavior of a CPU applied to the embodiment in FIG. 2;

FIG. 10 is a flowchart showing another portion of behavior of the CPU applied to the embodiment in FIG. 2;

FIG. 11 is a flowchart showing still another portion of behavior of the CPU applied to the embodiment in FIG. 2;

FIG. 12 is a flowchart showing yet another portion of behavior of the CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2; and

FIG. 15 is a block diagram showing a configuration of another embodiment of the present invention.

### DETAILED DESCRIPTION OF THE PREFERRED EMBODIMENTS

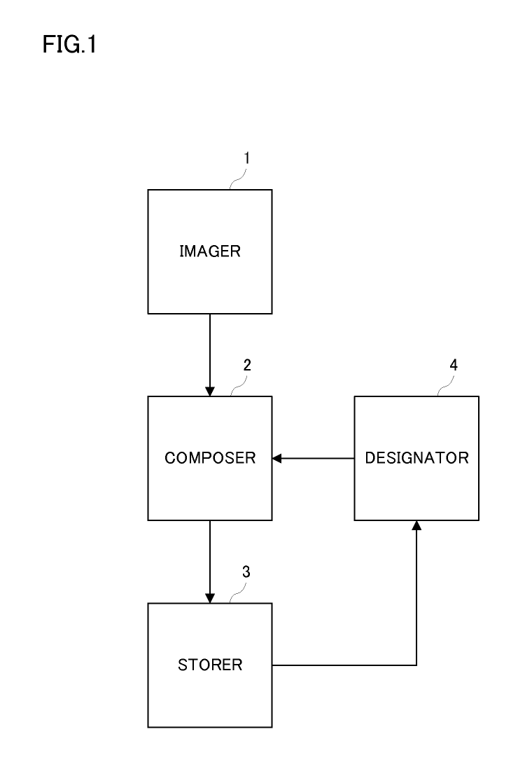

With reference to FIG. 1, an image generating apparatus according to one embodiment of the present invention is basically configured as follows: An imager 1 repeatedly outputs an image representing a scene captured on an imaging surface. A composer 2 composes the image outputted from the imager 1 and a designated image in an output cycle of the imager 1. A storer 3 stores a plurality of composed images generated by the composer 2. A designator 4 designates, out of the plurality of composed images stored in the storer 3, a composed image of equal to or more than two cycles past as the designated image.

The image outputted from the imager 1 is composed on the designated image, and the generated plurality of composed images are stored. Out of the plurality of composed images thus stored, a composed image of equal to or more than two cycles past is designated as the designated image.

Thus, when a moving object is captured on the imaging surface, it becomes possible to realize a special effect process representing a trajectory of a motion, by repeating the composing. Moreover, a degradation of the past image resulting from repeating the composing is inhibited and a length of the trajectory of the motion is lengthened, by composing the composed image of equal to or more than two cycles past. Therefore, it becomes possible to improve an effect of the special effect process.

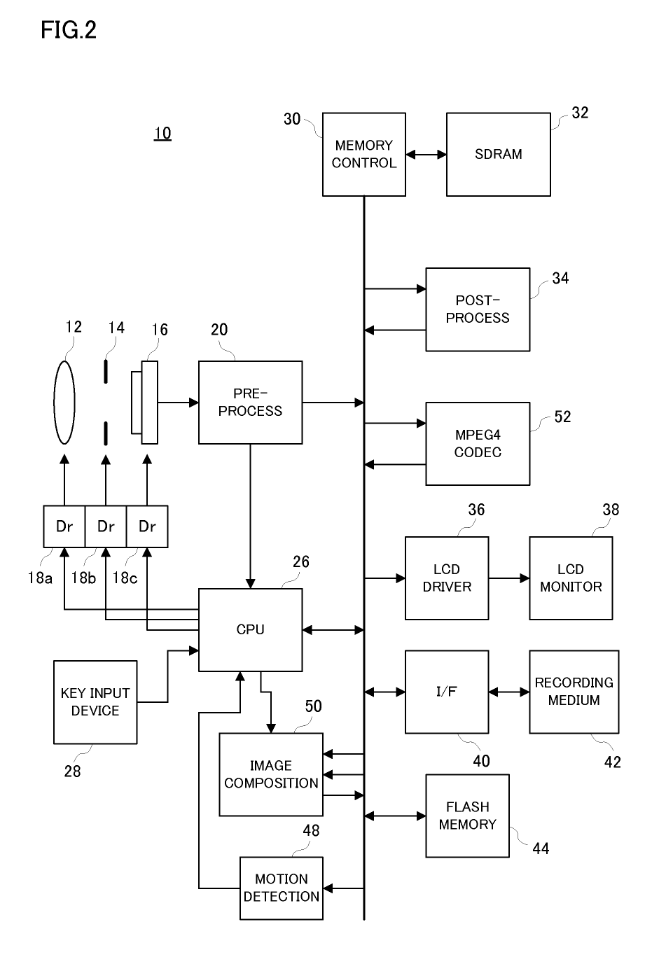

With reference to FIG. 2, a digital video camera 10 according to one embodiment includes a focus lens 12 and an aperture unit 14 driven by drivers 18a and 18b, respectively. An optical image that underwent these components enters, with irradiation, an imaging surface of an image sensor 16, and is subjected to a photoelectric conversion. Thereby, electric charges representing a scene are produced.

When a power source is applied, under a main task, a CPU 26 determines a state of a mode changing button 28md arranged in a key input device 28 (i.e., an operation mode at a current time point). The CPU 26 activates a strobe-imaging task when a strobe imaging mode is selected by the mode setting switch 28md arranged in the key input device 28, and activates a strobe reproducing task when a strobe reproducing mode is selected by the same mode setting switch 28md.

When the strobe-imaging task is activated, the CPU 26 activates a driver 18c in order to execute a moving image taking process. In response to a vertical synchronization signal Vsync generated at every 1/60th of a second, the driver 18c exposes the imaging surface and reads out the electric charges produced on the imaging surface in a progressive scanning manner. From the image sensor 16, raw image data representing the scene is outputted at a frame rate of 60 fps.

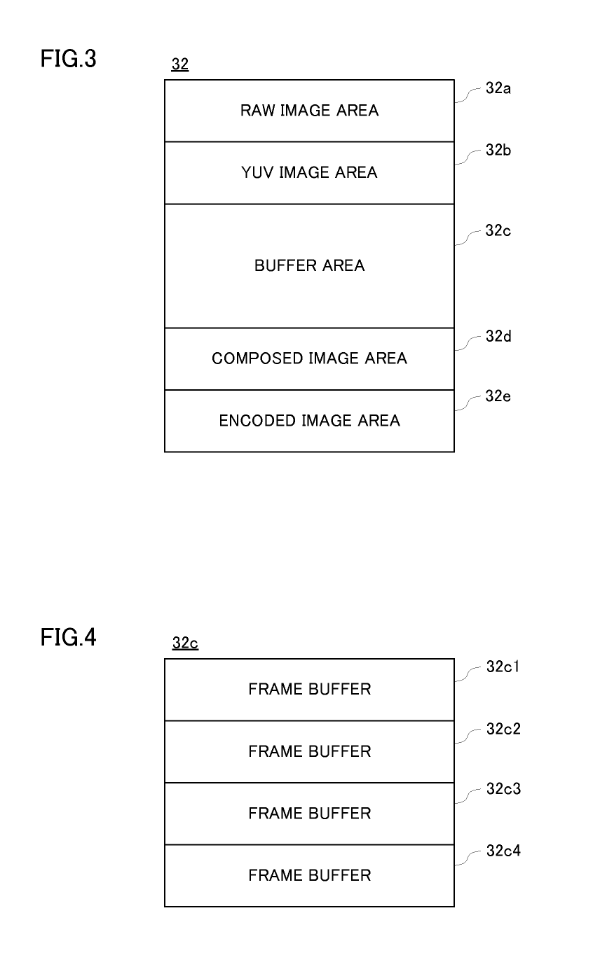

A pre-processing circuit 20 performs processes, such as digital clamp, pixel defect correction, and gain control, on the raw image data outputted from the image sensor 16. The raw image data on which the pre-processes are performed is written into a raw image area 32a (see FIG. 3) of an SDRAM 32 through a memory control circuit 30.

A post-processing circuit 34 accesses the raw image area 32a through the memory control circuit 30 so as to read out the raw image data in the progressive scanning manner at every 1/60th of a second. The read-out raw image data is subjected to processes such as color separation, white balance adjustment, YUV conversion, edge emphasis and zoom operation, and as a result, YUV image data is created. The created YUV image data is written into a YUV image area 32b (see FIG. 3) of the SDRAM 32 through the memory control circuit 30.

An LCD driver 36 repeatedly reads out the YUV image data stored in the YUV image area 32b, reduces the read-out image data so as to be adapted to a resolution of an LCD monitor 38, and drives the LCD monitor 38 based on the reduced image data. As a result, a real-time moving image (live view image) representing the scene is displayed on the LCD monitor 38.

Moreover, the pre-processing circuit 20 simply converts the raw image data into Y data, and applies the converted Y data to the CPU 26. The CPU 26 performs an AE process on the Y data so as to calculate an appropriate EV value. An aperture amount and an exposure time period defining the calculated appropriate EV value are respectively set to the drivers 18b and 18c, and as a result, a brightness of the live view image is moderately adjusted. Furthermore, the CPU 26 performs an AF process on a high-frequency component of the Y data when an AF start-up condition is satisfied. The focus lens 12 is placed at a focal point by the driver 18a, and thereby, a sharpness of the live view image is continuously improved.

When a recording start operation is performed toward the key input device 28, the CPU 26 accesses a recording medium 42 through an I/F 40 under the strobe-imaging task so as to newly create an MPEG4 file onto the recording medium 42. The created MPEG4 file is opened.

In the strobe-imaging task, executed is a process for a so-called photographing with strobe light, representing the trajectory of the motion of the object. Upon completion of a process for creating and opening a file, the CPU 26 commands an image composing circuit 50 to execute a process of composing the frame image generated by composing the past plurality of YUV images and the latest YUV image, at every time the vertical synchronization signal Vsync is generated. As a result of repeating the composing process, the trajectory of the motion of the object is represented in each frame image configuring the moving image.

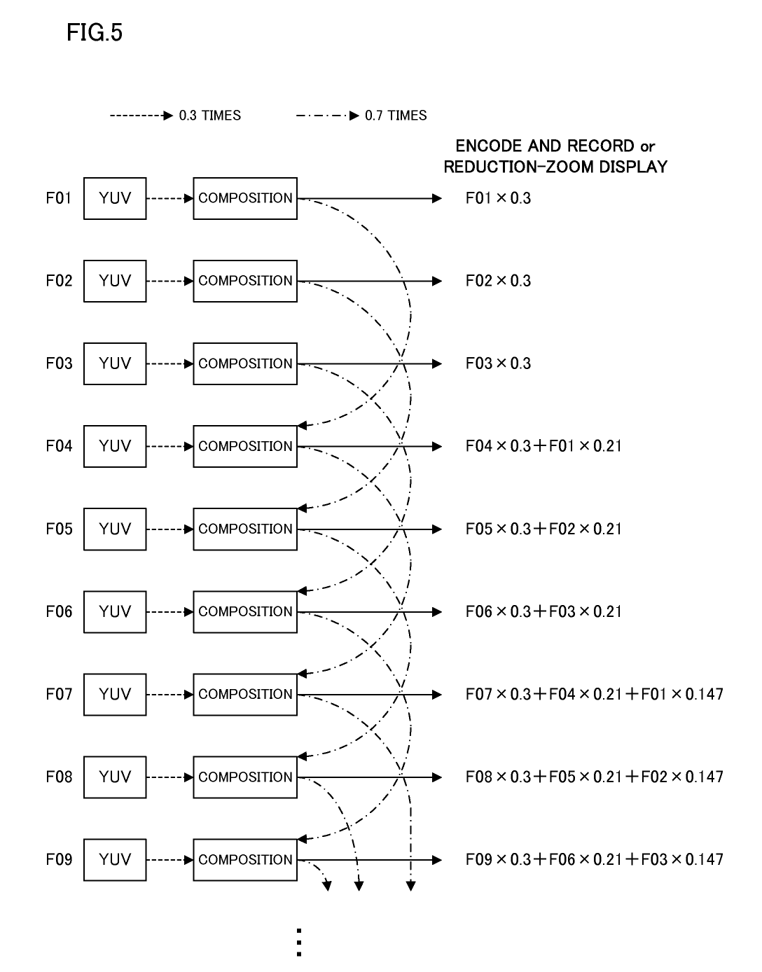

With reference to FIG. 3, a buffer area 32c is arranged in the SDRAM 32 for the composing process. With reference to FIG. 4, the buffer area 32c is configured by four frame buffers 32c1 to 32c4 for storing the composed image data generated by the composing process as frame image data.

The composed image data generated by the composing process is stored in a composed image area 32d (see FIG. 3), and is stored in the frame buffer 32c1 as the frame image data, concurrently. When a succeeding composing process is executed, the frame image data stored in the frame buffer 32c1 is moved to the frame buffer 32c2 whereas frame image data newly generated is stored in the frame buffer 32c1.

Thus, the frame image data generated by the composing process is moved in order of the frame buffers 32c1, 32c2, 32c3 and 32c4, at every time the composing process is executed thereafter. It is noted that, when a new composing process is executed, the frame image data stored in the frame buffer 32c4 is deleted. That is, a maximum of four frame image data generated recently is stored in the buffer area 32c.

In the composing process, composed are an image indicated by the YUV image data stored in the YUV image area 32b and an image indicated by any one of the four frame image data stored in the frame buffers 32c1 to 32c4.

When the moving object is captured in each of the YUV images, a position occupied by a partial image equivalent to the object is different in each of the images. Thus, these plurality of partial images appear in a single composed image as a result of the composing process. As a result of repeating the composing process, the partial image included in the single composed image is increased, and the trajectory of the motion of the object appears. Moreover, an image of a composing target is selected in a manner described below so that the trajectory of the motion of the object becomes clear.

A motion detecting circuit 48 acquires the latest YUV image data stored in the YUV image area 32b at every time the vertical synchronization signal Vsync is generated, and repeatedly creates motion information indicating a motion of the object appeared in the imaging surface among a plurality of frames. The created motion information is applied to the CPU 26. Based on the motion information, the CPU 26 selects frame image data to be a target of being composed on the latest YUV image, from among the four frame image data stored in the frame buffers 32c1 to 32c4.

For example, when the object moves at a high speed, new frame image data is selected whereas when the object moves at a low speed, old frame image data is selected. Moreover, upon the selecting, a frame rate of the image sensor 16 may be considered. For example, when the frame rate of the image sensor 16 is high, the old frame image data may be selected whereas when the frame rate of the image sensor 16 is low, the new frame image data may be selected.

As a result of selecting, a position of each of the plurality of partial images equivalent to the object has a mutually moderate interval in the composed image, and therefore, the trajectory of the motion of the object becomes clear.

It is noted that, when the motion of the object is not detected, the CPU 26 selects frame image data stored in a predetermined frame buffer out of the frame buffers 32c1 to 32c4. For example, when the motion of the object is not detected, the frame image data stored in the frame buffer 32c3 may be used as the composing target.

In the composing process, after a signal indicated by the YUV image data is multiplied by a coefficient K and a signal indicated by the selected frame image data is multiplied by a coefficient 1-K, the composed image data is generated by composing these two signals. It is noted that the coefficient K may be a value satisfying “0<K<1”.

With reference to FIG. 5, for example, when the coefficient K is set to “0.3” and the frame image data stored in the frame buffer 32c3 is used as the composing target, the composing process is executed in a manner described below. At a time point at which YUV image data “F01” indicating a head frame immediately after the recording start operation is created in the YUV image area 32b, the frame image data is not stored in any of the frame buffers 32c1 to 32c4. Thus, an image indicating “F01×0.3” is generated by the composing process. The generated composed image data is stored in the composed image area 32d, and is stored first in the frame buffer 32c1 as the frame image data, concurrently.

Subsequent to “F01”, at a time point at which each of YUV image data “F02” and “F03” is created in the YUV image area 32b, the frame image data is not stored in the frame buffers 32c3. Thus, images indicating “F02×0.3” and “F03×0.3” are generated by the composing process.

Subsequent to “F03”, at a time point at which YUV image data “F04” is created in the YUV image area 32b, the frame image data is not stored in the frame buffers 32c4. However, in the frame buffers 32c3, 32c2 and 32c1, the frame image data indicating “F01×0.3”, “F02×0.3” and “F03×0.3” are respectively stored.

Thus, a signal indicating “F04×0.3” and a signal indicating “F01×0.3×0.7” are composed by a composing process executed first at this time point based on a plurality of images. As a result, composed image data indicating “F04×0.3+F01×0.21” is generated and stored in the composed image area 32d, and concurrently in the frame buffer 32c1 as the frame image data.

Similarly, when YUV image data “F05” and “F06” are created, composed image data indicating “F05×0.3+F02×0.21” and composed image data indicating “F06×0.3+F03×0.21” are respectively generated and stored in the composed image area 32d, and concurrently in the frame buffer 32c1 as the frame image data.

At a time point at which YUV image data “F07” is created in the YUV image area 32b, the frame image data indicating “F04×0.3+F01×0.21” is stored in the frame buffers 32c3.

Thus, a signal indicating “F07×0.3” and the signal indicating “(F04×0.3+F01×0.21)×0.7” are composed. As a result, composed image data indicating “F07×0.3+F04×0.21+F01×0.147” is generated and is stored in the frame buffer 32c1 as the frame image data.

Thus, since the YUV images “F07”, “F04” and “F01” are composed, when a moving object is captured in each of the YUV images, a plurality of partial images each equivalent to the object appear in a single composed image by the composing process.

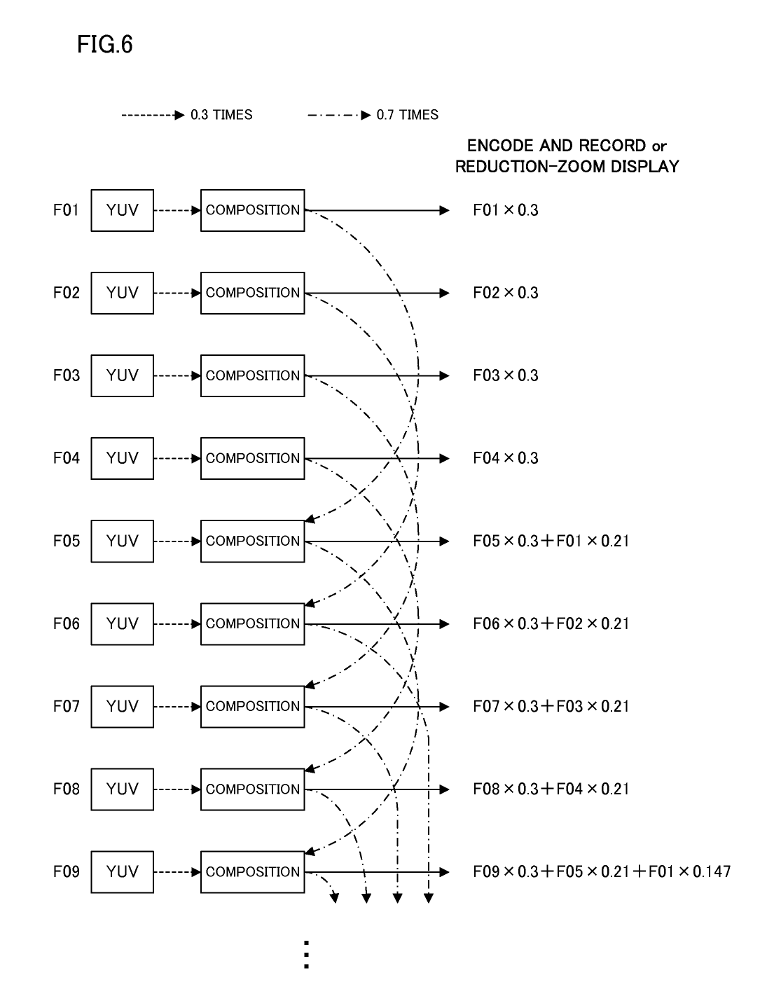

With reference to FIG. 6, when the frame image data stored in the frame buffer 32c4 is used as the composing target, the composing process is executed in a manner described below.

At a time point at which the YUV image data “F01”, “F02”, “F03” and “F04” are created, the frame image data is not stored in the frame buffer 32c4. However, at a time point at which the YUV image data “F05” is created in the YUV image area 32b, the frame image data indicating “F01×0.3” is stored in the frame buffers 32c4. Thus, the composing process is executed first at this time point, and composed image data indicating “F05×0.3+F01×0.21” is created and stored in the frame buffer 32c1 as the frame image data.

With regard to YUV image data created thereafter, except that the frame image data stored in the frame buffer 32c4 is used as the composing target, the composing process is executed similarly as an example shown in FIG. 5.

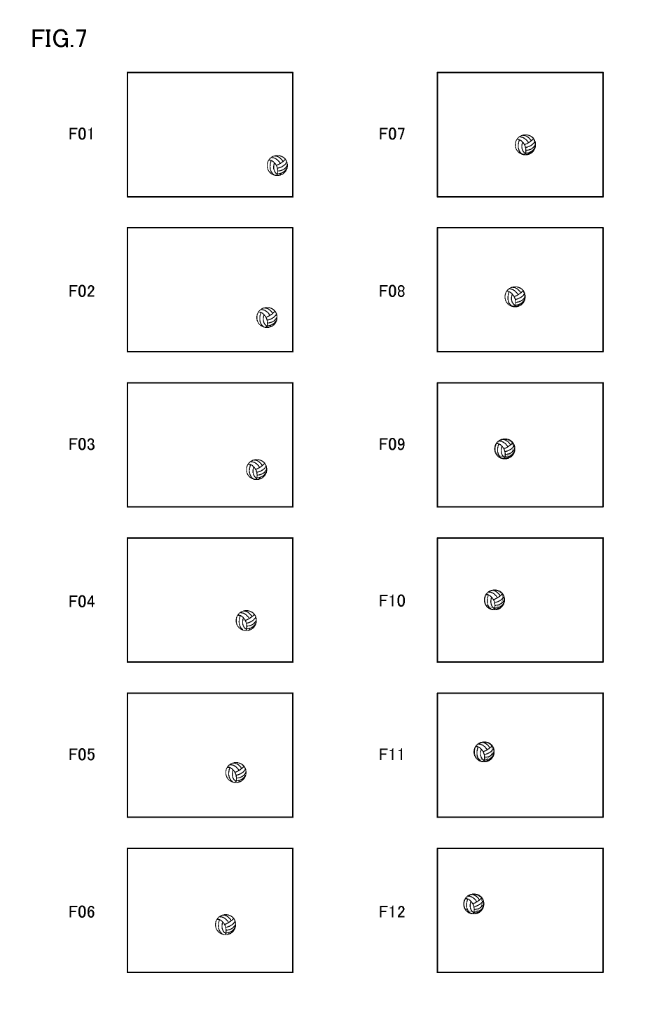

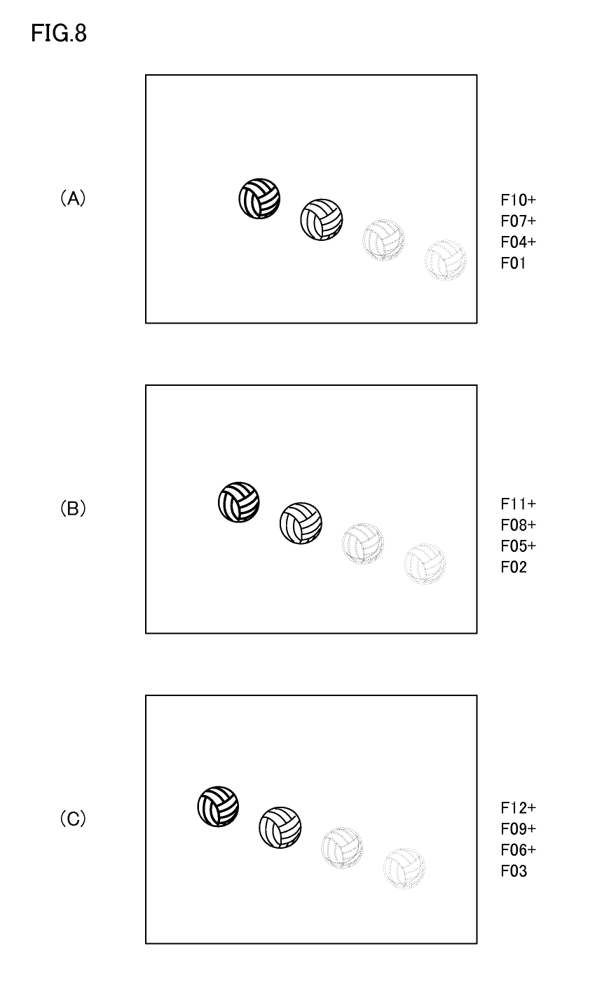

With reference to FIG. 7, for example, when a ball moving from a lower right to a upper left is captured in each of YUV images “F01” to “F12”, frame images shown in FIG. 8(A) to (C) is created by the composing process.

When the frame image data stored in the frame buffer 32c3 is used as the composing target, the frame image data created by composing the YUV image data “F07”, “F04” and “F01” is stored in the frame buffers 32c3, at a time point at which YUV image data “F10” is created. Thus, as shown in FIG. 8 (A), created is a frame image including partial images equivalent to the ball captured in each of the YUV images “F10”, “F07”, “F04” and “F01”.

Similarly, at a time point at which the YUV image data “F11” and “F12” are created, frame images shown in FIGS. 8 (B) and (C) are respectively created. The frame image shown in FIG. 8 (B) includes partial images equivalent to the ball captured in each of the YUV images “F11”, “F08”, “F05” and “F02”. The frame image shown in FIG. 8 (C) includes partial images equivalent to the ball captured in each of the YUV images “F12”, “F09”, “F06” and “F03”.

It becomes possible to create a moving image in which the trajectory of the motion of the object is represented, by using the frame image thus created.

When the composed image data is stored in the composed image area 32d by the composing process described above, an MPEG4 codec 52 repeatedly reads out the composed image data stored in the composed image area 32d through the memory control circuit 30, encodes the read-out image data according to an MPEG4 system, and writes the encoded image data, i.e., MPEG4 data into an encoded image area 32e (see FIG. 3) through the memory control circuit 30.

Thereafter, the CPU 26 transfers the latest 60 frames of the MPEG4 data to the MPEG4 file in an opened state at every time the 60 frames of the MPEG4 data is acquired. The latest 60 frames of the MPEG4 data are read out from the encoded image area 32e by the memory control circuit 30 so as to be written into the MPEG4 file through the I/F 40.

When the recording end operation is performed toward the key input device 28, in order to end an MPEG4 encoding process, the CPU 26 stops the MPEG4 codec 52.

Thereafter, the CPU 26 executes a termination process. Thereby, less than 60 frames of the MPEG4 data remaining in the SDRAM 32 are written into the MPEG4 file. The MPEG4 file in the opened state is closed after the termination process is completed.

The composing process described above may be used for a time of reproducing a moving image file recorded by a normal process. When a reproducing start operation is performed through the key input device 28, under the strobe reproducing task, the MPEG4 data stored in the designated MPEG4 file is read out through the I/F 40, and the read-out MPEG4 data is written into the encoding image area 32e through the memory control circuit 30.

The MPEG codec 52 decodes the written MPEG4 data according to the MPEG4 system, and writes the decoded image data, i.e., the YUV image data into the YUV image area 32b through the memory control circuit 30.

The CPU 26 executes the composing process described above at every time decoding one frame is completed and the YUV image data is written into the YUV image area 32b.

The LCD driver 36 reads out the composed image data stored in the composed image area 32d, reduces the read-out image data so as to be adapted to the resolution of the LCD monitor 38, and drives the LCD monitor 38 based on the reduced image data. As a result, an image corresponding to one frame of a designated moving-image file is displayed on the LCD monitor 38.

As a result of the process being executed at every time decoding the one frame is completed, the trajectory of the motion of the object is represented when reproducing the moving image.

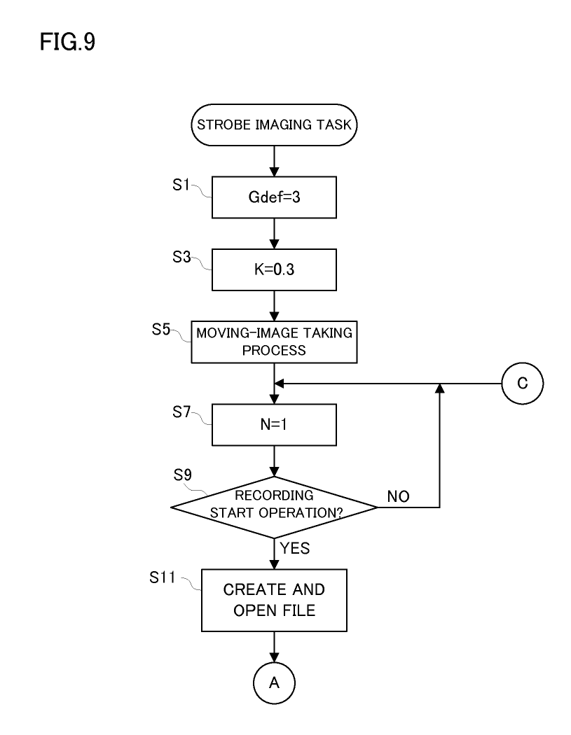

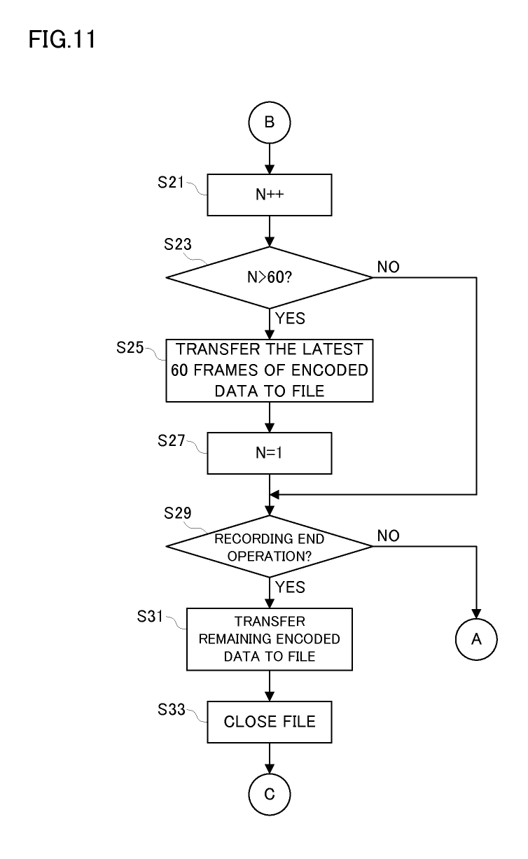

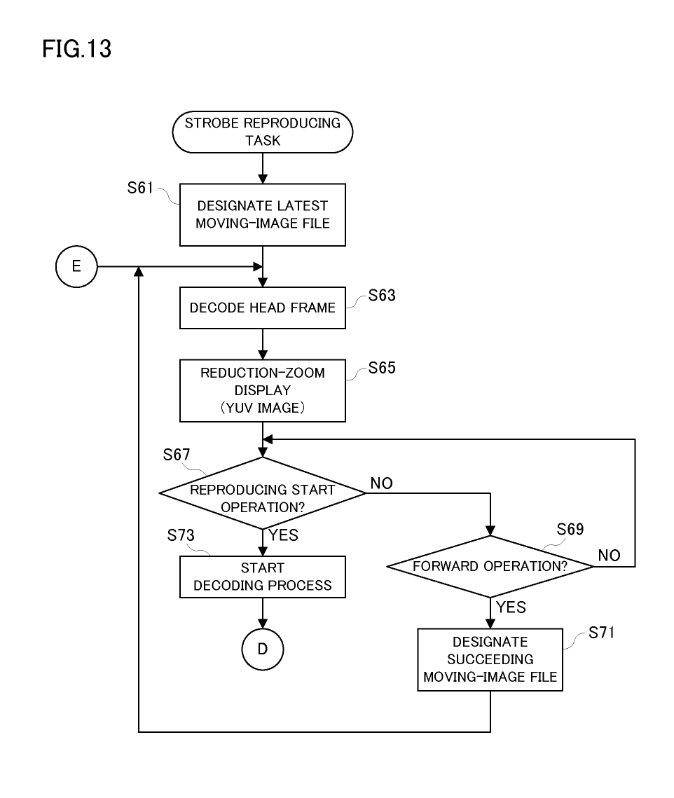

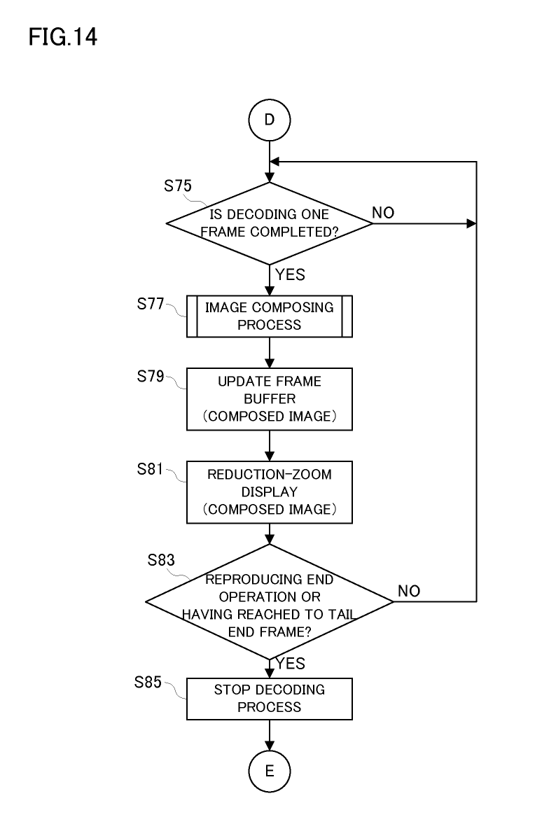

The CPU 26 executes a plurality of tasks including the strobe imaging task shown in FIG. 9 to FIG. 11 and the strobe reproducing task shown in FIG. 13 to FIG. 14, in a parallel manner. It is noted that, control programs corresponding to these tasks are stored in a flash memory 44.

With reference to FIG. 9, in a step S1, a predetermined value Gdef of a variable G is set to “3”, and in a step S3, a variable K is set to “0.3”. In a step S5, the moving-image taking process is started. As a result, a live view image is displayed on the LCD monitor 38.

In a step S7, a variable N is set to “1”, and in a step S9, it is determined whether or not the recording start operation is performed. When a determined result is NO, the process returns to the step S7 whereas when the determined result is YES, the process advances to a step S11. In the step S11, the MPEG4 file is newly created in the recording medium 42. The created MPEG4 file is opened.

In a step S13, it is repeatedly determined whether or not the vertical synchronization signal Vsync is generated, and when a determined result is updated from NO to YES, in a step S15, the image composing process is executed.

In a step S17, the frame image data generated by the composing process are moved among the frame buffers; from 32c1 to 32c2, from 32c2 to 32c3, and from 32c3 to 32c4. The frame image data stored in the frame buffer 32c4 is deleted.

In a step s19, the MPEG4 codec 52 is commanded to encode the composed image data. The MPEG4 codec 52 reads out the composed image data stored in the composed image area 32d by the process in the step S15, and encodes the read-out composed image data according to the MPEG4 system. The encoded image data is stored in the encoded image area 32e (see FIG. 3) through the memory control circuit 30.

In a step S21, the variable N is incremented, and in a step S23, it is determined whether or not the variable N exceeds “60” as a result. When a determined result is NO, the process advances to a step S29 whereas when the determined result is YES, the process advances to the step S29 via processes in steps S25 and S27.

In the step S25, the latest 60 frames of the encoded image data is transferred to the MPEG4 file in the opened state. The latest 60 frames of the MPEG4 data are read out from the encoded image area 32e by the memory control circuit 30 so as to be written into the MPEG4 file through the I/F 40.

In the step S27, the variable N is set to “1”, and in the step S29, it is determined whether or not the recording end operation is performed. When a determined result is NO, the process returns to the step S13 whereas when the determined result is YES, the process advances to a step S31.

In the step S31, a termination process is executed, and less than 60 frames of the MPEG4 data remaining in the SDRAM 32 are written into the MPEG4 file. In a step S33, the MPEG4 file in the opened state is closed, and thereafter, the process returns to the step S7.

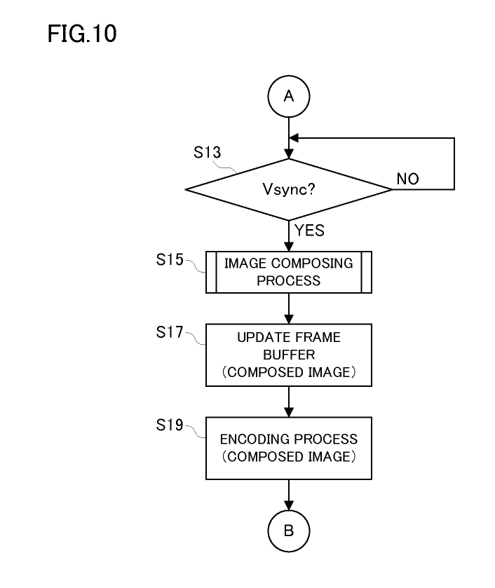

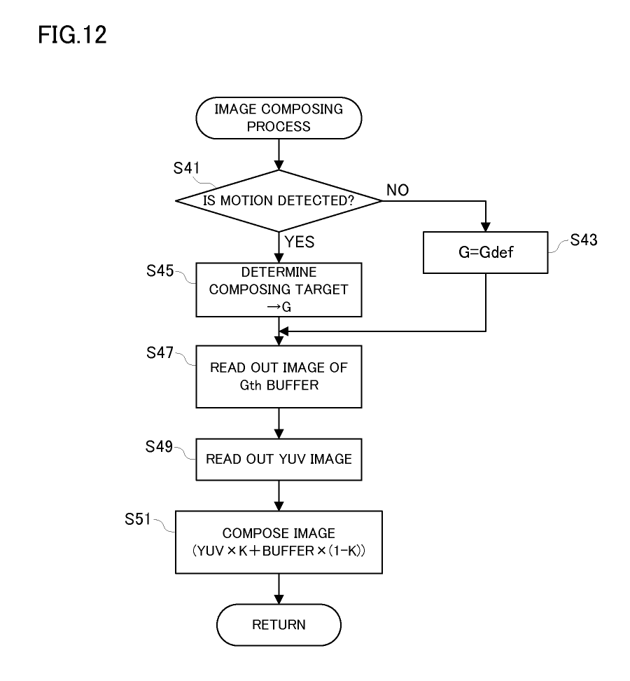

The image composing process in the step S15 shown in FIG. 10 and the step S77 shown in FIG. 14 is executed according to a subroutine shown in FIG. 12. In a step S41, it is determined whether or not a motion of the object appeared in the imaging surface is detected based on the motion information applied from the motion detecting circuit 48. When a determined result is NO, the process advances to a step S47 via a step S43 whereas when the determined result is YES, the process advances to the step S47 via a step S45.

In the step S43, the variable G is set to the predetermined value Gdef. In the step S45, based on a speed of the motion of the object detected in the step S41, frame image data stored in the G-th frame buffer is determined as the composing target. In the step S47, the composed image data is read out from the G-th frame buffer out of the frame buffers 32c1 to 32c4. In a step S49, the YUV image data is read out from the YUV image area 32b.

In a step S51, after a signal indicated by the YUV image data read out in the step S49 is multiplied by the coefficient K and a signal indicated by the composed image data read out in the step S47 is multiplied by the coefficient 1-K, these two signals are composed. As a result, the generated composed image data is stored in the composed image area 32d. Upon completion of the process in the step S51, the process returns to the routine in an upper hierarchy.

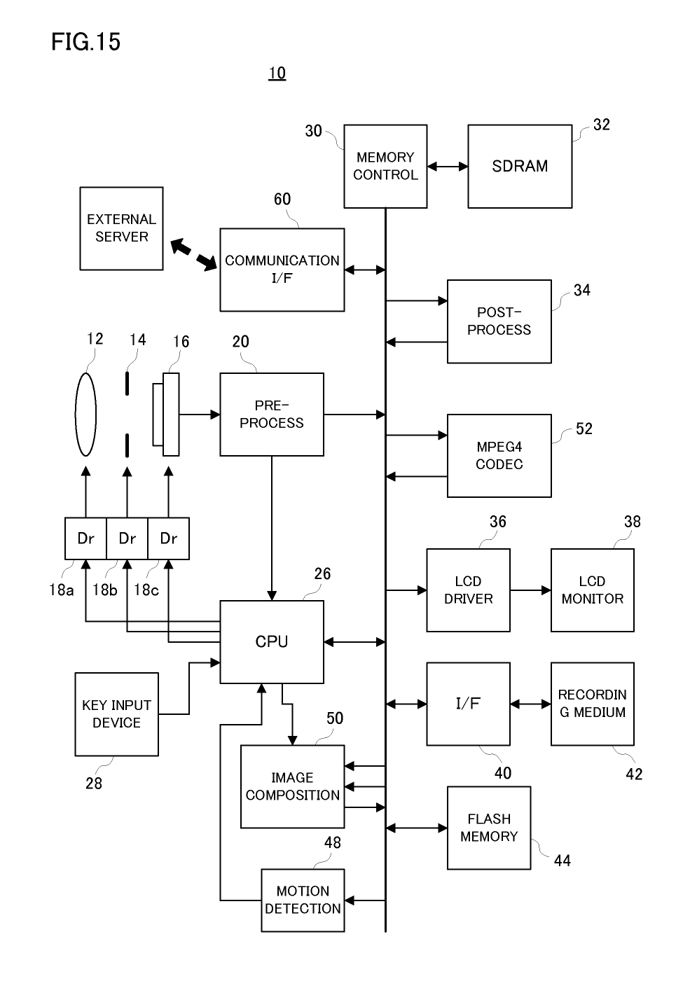

With reference to FIG. 15, in a step S61, the latest moving-image file recorded in the recording medium 42 is designated, and in a step S63, the MPEG4 codec 52 is commanded to decode a head frame of the designated moving-image file. Encoded image data corresponding to the head frame of the designated moving-image file is read out to the encoded image area 32e. The MPEG codec 52 decodes the read-out MPEG4 data according to the MPEG4 system. YUV image data corresponding to the head frame is created in the YUV image area 32b by the decoding.

In a step S65, the LCD driver 36 is commanded to perform reduction-zoom display based on the YUV image data stored in the YUV image area 32b. The LCD driver 36 reads out the YUV image data stored in the YUV image area 32b, reduces the read-out image data so as to be adapted to a resolution of the LCD monitor 38, and drives the LCD monitor 38 based on the reduced image data. As a result, a still image corresponding to a head frame of the designated moving-image is displayed on the LCD monitor 38.

In the step S67, it is determined whether or not the reproducing start operation is performed, and when a determined result is NO, it is determined whether or not a forward operation is performed in a step S69. When a determined result of the step S69 is NO, the process returns to the step S67 whereas when the determined result of the step S69 is YES, a succeeding moving-image file is designated in a step S71, and thereafter, the process returns to the step S63. As a result, a still image corresponding to a head frame of the succeeding moving image file is displayed on the LCD monitor 38.

When the determined result of the step S67 is NO, in a step S73, the MPEG4 codec 52 is commanded to start the decoding process for the whole designated moving-image files.

Encoded image data of the designated moving-image file is sequentially read out to the encoded image area 32e by the decoding process in the step S73. The MPEG4 codec 52 decodes the read-out encoded image data according to the MPEG4 system. As a result, in a step S75, it is determined whether or not decoding one frame is completed, and when a determined result is updated from NO to YES, in a step S77, the image composing process is executed.

In a step S79, the frame image data generated by the composing process are moved among the frame buffers; from 32c1 to 32c2, from 32c2 to 32c3, and from 32c3 to 32c4. The frame image data stored in the frame buffer 32c4 is deleted.

In a step S81, the LCD driver 36 is commanded to perform reduce and zoom display based on the composed image data stored in the composed image area 32d. The LCD driver 36 reads out the composed image data stored in the composed image area 32d, reduces the read-out image data so as to be adapted to the resolution of the LCD monitor 38, and drives the LCD monitor 38 based on the reduced image data. As a result, an image corresponding to one frame of the designated moving-image is displayed on the LCD monitor 38.

In a step S83, it is determined whether or not an OR condition under which the reproducing end operation is performed or the reproduced image has reached an end frame. When a determined result is NO, the process returns to the step S75 whereas when the determined result is YES, in a step S85, the MPEG4 codec 52 is commanded to stop the decoding process. Upon completion of the process in the step S85, the process returns to the step S63.

As can be seen from the above-describe explanation, the image sensor 16 repeatedly outputs the image representing the scene captured on the imaging surface. The CPU 26 executes the process of composing the image outputted from the image sensor 16 and the designated image in the output cycle of the image sensor 16, and stores the generated plurality of composed images. Moreover, the CPU 26 designates, out of the stored plurality of composed images, the composed image of equal to or more than two cycles past as the designated image.

The image outputted from the image sensor 16 is composed on the designated image, and the generated plurality of composed images are stored. Out of the plurality of composed images thus stored, the composed image of equal to or more than two cycles past is designated as the designated image.

Thus, when the moving object is captured on the imaging surface, it becomes possible to realize the special effect process representing the trajectory of the motion, by repeating the composing. Moreover, the degradation of the past image resulting from repeating the composing is inhibited and the length of the trajectory of the motion is lengthened, by composing the composed image of equal to or more than two cycles past. Therefore, it becomes possible to improve the effect of the special effect process.

It is noted that, in this embodiment, in a case where the frame image data is not stored in the frame buffer of the composing target, such as when a process for a frame near a head frame is performed, the image data generated by multiplying the YUV image data by the coefficient “1-K” is stored in the frame buffer 32c1 as the frame image data. However, in order to stabilize an intensity of the signal indicated by the generated composed image data, the YUV image data may directly be stored in the frame buffer 32c1 as the frame image data in the case where the frame image data is not stored in the frame buffer of the composing target It is noted that, in this embodiment, the number of the frame buffers is assumed as four. However, as long as the number is plural, frame buffers other than four may be prepared.

It is noted that, in this embodiment, used are the image composing circuit and the plurality of frame buffers. However, the above described process may be executed by using a three-dimensional Digital Noise Reduction. In this case, it becomes possible to reduce the number of the components.

It is noted that, in this embodiment, the control programs equivalent to the multi task operating system and a plurality of tasks executed thereby are previously stored in the flash memory 44. However, a communication I/F 60 may be arranged in the digital camera 10 as shown in FIG. 15 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the strobe imaging task shown in FIG. 9 to FIG. 11 and the strobe reproducing task shown in FIG. 13 to FIG. 14. However, these tasks may be further divided into a plurality of small tasks, and furthermore, a part of the divided plurality of small tasks may be integrated into another task. Moreover, when a transferring task is divided into the plurality of small tasks, the whole task or a part of the task may be acquired from the external server.

Moreover, in this embodiment, the present invention is explained by using a digital video camera, however, a digital still camera, cell phone units or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image generating apparatus, comprising:
an imager which repeatedly outputs an image representing a scene captured on an imaging surface;
a composer which composes the image outputted from said imager and a designated image in an output cycle of said imager;
a storer which stores a plurality of composed images generated by said composer; and
a designator which designates, out of the plurality of composed images stored in said storer, a composed image of equal to or more than two cycles past as the designated image.

2. An image generating apparatus according to claim 1, further comprising a creator which creates moving-image data by using the plurality of composed images generated by said composer.

3. An image generating apparatus according to claim 1, further comprising a displayer which displays a moving image by using the plurality of composed images generated by said composer.

4. An image generating apparatus according to claim 1, further comprising:
a detector which detects a motion of an object appeared in the scene captured on the imaging surface; and
a controller which controls a designating manner of said designator based on a detection result of said detector.

5. An image generating apparatus according to claim 4, wherein said detector detects a speed of the motion of the object, said controller controls the designating manner of said designator to a past direction according to an increase of the speed detected by said detector and controls the designating manner of said designator to a future direction according to a decrease of the speed detected by said detector.

6. An image generating apparatus according to claim 1, wherein said composer executes the process by performing a weighting on each of the image outputted from said imager and the designated image.

7. An image generating program recorded on a non-transitory recording medium in order to control an image generating apparatus provided with an imager which repeatedly outputs an image representing a scene captured on an imaging surface, the program causing a processor of the image generating apparatus to perform the steps comprises:
a composing step of composing the image outputted from said imager and a designated image in an output cycle of said imager;
a storing step of storing a plurality of composed images generated by said composing step; and
a designating step of designating, out of the plurality of composed images stored in said storing step, a composed image of equal to or more than two cycles past as the designated image.

8. An image generating method executed by an image generating apparatus provided with an imager which repeatedly outputs an image representing a scene captured on an imaging surface, comprising:
a composing step of composing the image outputted from said imager and a designated image in an output cycle of said imager;
a storing step of storing a plurality of composed images generated by said composing step; and
a designating step of designating, out of the plurality of composed images stored in said storing step, a composed image of equal to or more than two cycles past as the designated image.
